(19) United States
(12) Patent Application Publication
(10) Pub. No.: US 2008/0287107 A1
(43) Pub. Date: Nov. 20, 2008

(54) System and Method for Providing Advertisements Over a Communication Network Utilizing Shared-Revenue Incentives

(75) Inventor: Matthew Carinio, San Luis Obispo, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/750,156

(22) Filed: May 17, 2007

(51) Int. Cl. H04M 3/42

(52) U.S. Cl. 455/414.1

(57) ABSTRACT

Systems and methods for adverting over a communication network are disclosed. Generally, an attempt by a first communication device to communicate with a second communication device is detected. An advertisement is sent to the first communication device and an indication is stored in an account record associated with the second communication device that an advertisement was sent to the first communication device based on an attempt to communicate with the second communication device. An ad provider may then share revenue with a user associated with the second communication device based on the account record.

### BACKGROUND

As communication technologies develop, advertisers desire new systems and methods to utilize the developing technologies to deliver advertisements to new potential customers. One area of interest in advertising is serving advertisements to users communicating over networks such as cellular networks, voice over Internet protocol networks (“VOIP”), traditional telephone networks, and/or the Internet. Accordingly, it is desirable to develop systems and methods for providing advertisements to potential customers over communication networks, and for encouraging users to participate in programs that allow advertisers to provide advertisements to potential customers over communications networks.

### BRIEF DESCRIPTION OF THE DRAWINGS

FIG. 1 is a block diagram of one embodiment of a system for providing advertisements over a communication network utilizing shared-revenue incentives; and

FIGS. 2a and 2b are a flow chart of one embodiment of a method for providing advertisements over a communication network utilizing shared-revenue incentives.

### DETAILED DESCRIPTION OF THE DRAWINGS

Systems and methods for providing advertisements over a communication network utilizing shared-revenue incentives are disclosed. Generally, when a first user attempts to communicate with a second user, an ad provider serves an advertisement to the first user before completing the communication with the second user. For example, when a caller places a telephone call to a called party, an ad provider serves an advertisement to the caller before completing the telephone call. To encourage the called party to participate in programs that allow the ad provider to serve advertisements to callers attempting to place a telephone call to the called party, the ad provider may share with the called party a predetermined amount of revenue generated by the ad provider serving the advertisement to the caller. However, as discussed in more detail below, it will be appreciated that the disclosed systems and methods are not limited to telephone calls between two parties.

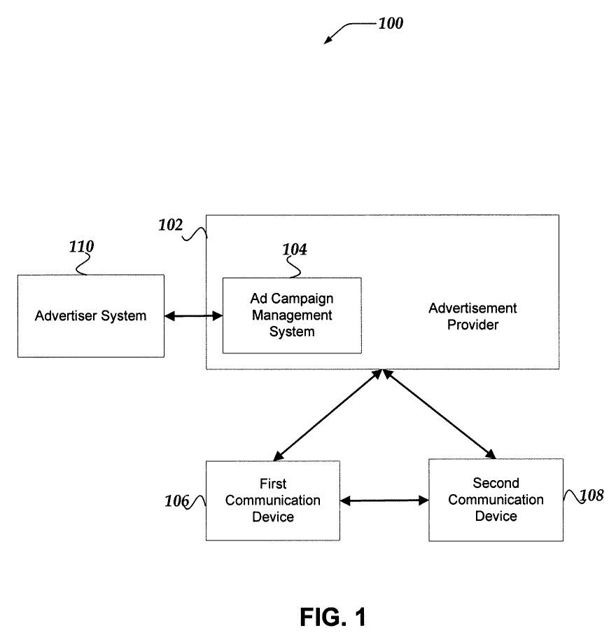

FIG. 1 is a block diagram of one embodiment of a system for providing advertisements over a communication network utilizing shared-revenue incentives. The system 100 includes an ad provider 102 including an ad campaign management system 104 that is operative to detect communications between a first communication device 106 and a second communication device 108, and communicate with at least the first communication device 106. In one implementation, the ad campaign management system 104 may be part of the ad provider 102, while in other implementations, the ad campaign management system 104 is distinct from the ad provider 102. The ad provider 102 and ad campaign management system 104 may communicate with each other over one or more internal or external networks, and may be implemented as software code running in conjunction with a processor such as a single server, a plurality of servers, or any other computing device known in the art.

The first and second communication devices 106, 108 may be a cellular telephone, a VOIP telephone, a wireless fidelity (“WiFi”) telephone, a landline telephone, a mobile device, a personal computer, a conference call bridge, or any other communication device known in the art. While the systems and methods below are described with respect to a first and second communication device 106, 108, it should be appreciated that the system for providing advertisements over a communication network utilizing shared-revenue incentives may be implemented with any number of communication devices.

A user (the “second user”) registers the second communication device 108 with the ad provider 102 to allow the ad provider 102 to serve advertisements to communication devices attempting to communicate with the second communication device 108. The attempt to communicate with the second communication device 108 may be the first communication device 106 initiating a telephone call to the second communication device 108, the first communication device 106 initiating an instant messaging communication with the second communication device 108, or the first communication device 106 initiating any other type of communication known in the art with the second communication device 108.

As an incentive for the second user to register the second communication device 108 with the ad provider 102, the ad provider 102 may agree to share with the second user the revenue that is generated by the ad provider 102 serving advertisements to communication devices attempting to communicate with the second communication device 108. In some implementations the second user will be compensated based on an action taken by a user (the “first user”) associated with the first communication device 106 receiving the advertisement. For example, as explained in more detail below, when the first communication device 106 attempts to communicate with the second communication device 108, if the first user agrees to receive an advertisement, the second user may receive a first amount from the ad provider; if the first user requests a discount identifier associated with the served advertisement, the second user may receive a second amount from the ad provider; and/or if the first user completes a purchase associated with the received discount identifier, the second user may receive a third amount from the ad provider. However, in other implementations, the ad provider may not provide a tiered compensation structure for the second user.

Before, after, or at the same time as the second user registers the second communication device 108 with the ad provider 102, an advertiser uses an advertiser system 110 to interact with the ad campaign management system 104 to create one or more advertisements. The ad provider 102 then serves the created advertisements to communication devices, such as the first communication device 106, that attempt to initiate a communication with devices such as the second communication device 108. The advertisements may be graphical advertisements; graphical advertisements based on textual offers such as those described in U.S. patent application Ser. No. 11/476,324, filed Jun. 28, 2006 and assigned to Yahoo! Inc.; video advertisements; audio advertisements; or any other type of media known in the art.

In addition to the advertisements, the advertiser may create one or more discount identifiers to be sent to a first communication device 106 that is attempting to initiate communication with devices such as the second communication device 108. In one implementation, the discount identifier may be a string of characters and/or numbers that represents a coupon offering a discount to be redeemed by a user. As explained in more detail below, the advertiser system 110 periodically, or in real time, updates the ad provider 102 regarding which discount identifiers have been redeemed so that that ad provider 102 may share revenue with communication devices, such as the second communication device 108, that has been generated based on a user redeeming a discount identifier that was served to a first communication device 106 attempting to communicate with the second communication device 108.

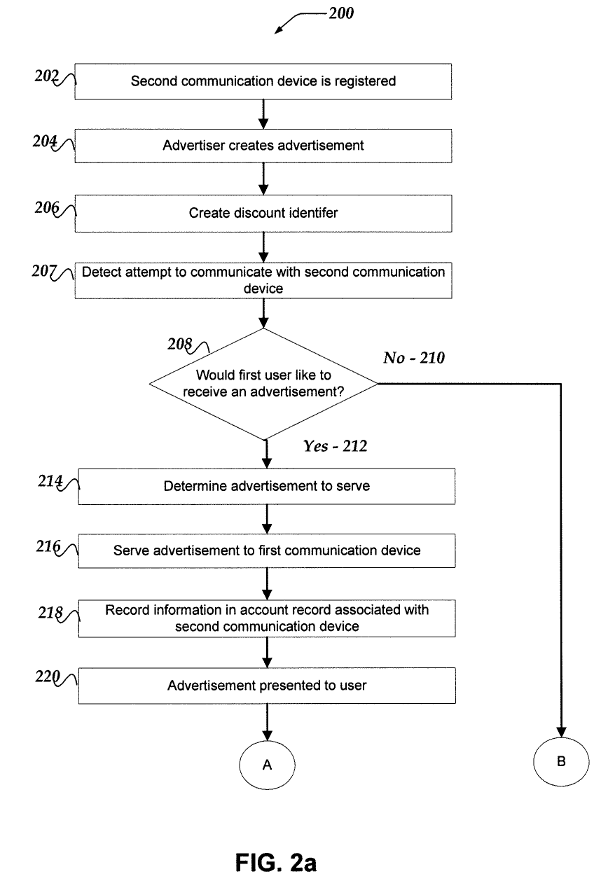

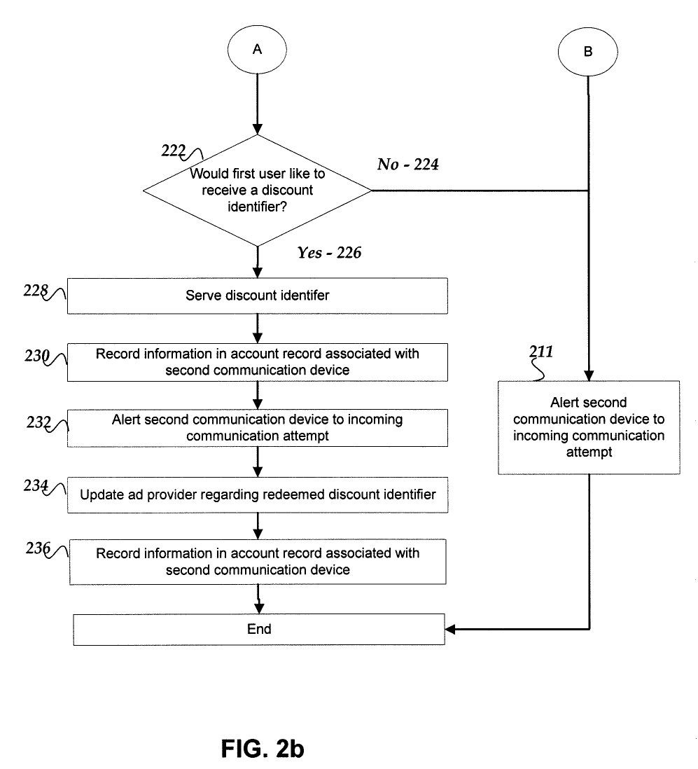

One method for providing advertisements over a communication network utilizing shared-revenue incentives is described below with respect to FIGS. 2a and 2b. The method begins with a second user registering a second communication device with the ad provider at step 202. Before, after, or at the same time as the second user registers the second communication device, an advertiser interacts with an ad campaign management system of an ad provider at step 204 to create one or more advertisements. Additionally, the advertiser may interact with the ad campaign management system to create one or more discount identifiers at step 206.

After the second communication device is registered with the ad provider, the ad provider monitors attempts to communicate with the second communication device until at step 207, the ad provider detects a first communication device attempting to communicate with the second communication device. Before the second communication device is alerted to the incoming communication, the ad provider may inquire at step 208 whether a first user associated with the first communication device is willing to receive an advertisement. If the first user is not willing to receive an advertisement (210), the second communication device is alerted to the incoming communication at step 211 and the method ends. However, if the first user is willing to receive an advertisement (212), the method proceeds to step 214. It should be appreciated that in some implementations, the ad provider may automatically serve an advertisement to the first communication device without inquiring whether the first user is willing to receive an advertisement.

At step 214, the ad provider determines an advertisement to serve to the first communication device. In some implementations, the ad provider may determine an advertisement to serve to the first communication device based on factors such as a time of day where the first communication device is located, a geographical location associated with where the first communication device is located, demographics of the first user that are known to the ad provider, demographics of the second user that are known to the ad provider, behavioral information from any means known to the ad provider, or any other type of information known to the ad provider that relates to the first and/or the second communication devices.

In some implementations the advertisement may be an audio advertisement that is transmitted to the first communication device. However, in other implementations where the ad provider can detect the capabilities of the first communication device, or the capabilities of the first communication device are known, the advertisement may also be a multimedia advertisement such as a graphical advertisement that is displayed on a display of the first communication device or a video ad that is displayed on a display of the first communication device.

The ad provider serves the advertisement to the first communication device at step 216 and records information at step 218 in an account record associated with the second communication device at the ad provider so that the ad provider may share with the second user an amount of revenue that is generated by serving the advertisement to the first communication device.

The first communication device presents the served advertisement to the first user at step 220. If the advertiser has associated a discount identifier with the presented advertisement, at step 222 the ad provider may inquire whether the first user would like to receive a discount identifier associated with the served advertisement. If the first user does not want a discount identifier (224), the second communication device is alerted to the incoming communication at step 211 and the method ends. However, if the user requests a discount identifier (226), the ad provider serves the discount identifier to the first communication device at step 228 and records information at step 230 in the account record associated with the second communication device so that the ad provider may share with the second user revenue that is generated by serving the discount identifier to the first communication device.

The discount identifier may be audibly presented to the first user via the first communication device, transmitted via text messaging to the first communication device, transmitted via short messaging service (“SMS”) to the first communication device, emailed to an email account associated with the first communication device, or transmitted to the first communication device via any other means known in the art.

After serving the discount identifier to the first communication device, the second communication device is alerted to the incoming communication at step 232. Periodically, or in real time, the advertiser updates the ad provider regarding what discount identifiers have been redeemed at step 234. In response to receipt of an update that the first user has redeemed a discount identifier sent to the first communication device at step 228, the ad provider records information at step 236 in the account record associated the second communication device so that the ad provider may share revenue with the second user that is generated by the first user redeeming the discount identifier.

FIGS. 1, 2a and 2b illustrate systems and methods for providing advertisements over a communication network that utilizing shared-revenue incentives. By providing advertisements over a communication network when a first communication device attempts to communicate with a second communication device, an ad provider is able to serve advertisements to users who the ad provider might not otherwise be able to serve advertisements to. Further, by targeting advertisements to potential customers based on a location or demographic of the potential customer, advertisers increase the probability of a potential customer completing a purchase.

It will be appreciated that the systems and methods described above may be used in instances other than personal communications such as personal phone calls or instant message conversations. For example, the disclosed systems and methods may be used as a replacement for traditional hold music or prerecorded messages. In one implementation, when a caller calls a business and is put on hold until a business employee is available to process the call, the caller may be presented with the opportunity to receive advertisements from an ad provider instead of presenting the caller with traditional hold music or pre-recorded messages. In another implementation, when a first caller calls into a conference call bridge and is put on hold until additional callers call into the conference call bridge, the first caller may be presented with the opportunity to receive advertisements from an ad provider rather than being presented with traditional hold music or other pre-recorded messages.

It is therefore intended that the foregoing detailed description be regarded as illustrative rather than limiting, and that it be understood that it is the following claims, including all equivalents, that are intended to define the spirit and scope of this invention.

1. A method for advertising over a communication network, the method comprising the acts of:
detecting an attempt by a first communication device to initiate communication with a second communication device;
sending an advertisement to the first communication device; and
storing an indication in an account record associated with the second communication device that an advertisement was sent to the first communication device based on the attempt to initiate communication with the second communication device.

2. The method of claim 1, further comprising:
sending a prompt to the first communication device to receive the advertisement; and
receiving a request from the first communication device to receive the advertisement;

3. The method of claim 1, further comprising:
receiving a request from the first communication device to receive a discount identifier associated with the advertisement;
sending the discount identifier to the first communication device; and
storing an indication in the account record associated with the second communication device that the discount identifier was sent to the first communication device based on the attempt to initiate communication with the second communication device.

4. The method of claim 3, further comprising:
receiving an indication that a transaction associated with the discount identifier sent to the first communication device has been completed; and
storing an indication in the account record associated with the second communication device that the transaction was completed based on the attempt to initiate communication with the second communication device.

5. The method of claim 1, further comprising:
compensating a user associated with the second communication device based on the record.

6. The method of claim 1, further comprising:
identifying the advertisement to send to the first communication device based on at least one of a geographic location associated with the first communication device, a time of day associated with the first communication device, a demographic of a user associated with the first communication device, and behavioral information associated with the user associated with the first communication device.

7. The method of claim 1, wherein the advertisement is one of an audio advertisement, a graphical advertisement, a graphical advertisement based on a textual offer, and a video advertisement.

8. The method of claim 1, wherein the first communication device is one of a cellular telephone, a mobile device, a voice over internet protocol (VOIP) telephone, a wireless fidelity (WiFi) telephone, a landline telephone, and a personal computer.

9. The method of claim 1, wherein the second communication device is a conference call bridge.

10. The method of claim 1, wherein the attempt to initiate communication with the second communication device is a telephone call placed to the second communication device.

11. A computer-readable storage medium comprising a set of instructions for advertising over a communication medium, the set of instructions to direct a processor to perform the acts of:
detecting an attempt by a first communication device to initiate communication with a second communication device;
sending a prompt to the first communication device to receive an advertisement;
receiving a request from the first communication device to receive the advertisement;
sending the advertisement to the first communication device; and
storing an indication in an account record associated with the second communication device that an advertisement was sent to the first communication device based on the attempt to initiate communication with the second communication device.

12. The computer-readable storage medium of claim 11, further comprising a set of instructions to direct a processor to perform the acts of:
receiving a request from the first communication device to receive a discount identifier associated with the advertisement;
sending the discount identifier to the first communication device; and
storing an indication in the account record associated with the second communication device that the discount identifier was sent to the first communication device based on the attempt to initiate communication with the second communication device.

13. The computer-readable storage medium of claim 12, further comprising a set of instructions to direct a processor to perform the acts of:
receiving an indication that a transaction associated with the discount identifier sent to the first communication device has been completed; and
storing an indication in the account record associated with the second communication device that the transaction was completed based on the attempt to initiate communication with the second communication device.

14. The computer-readable storage medium of claim 11, further comprising a set of instructions to direct a processor to perform the acts of:
compensating a user associated with the second communication device based on the record.

15. The computer-readable storage medium of claim 11, further comprising a set of instructions to direct a processor to perform the acts of:
identifying the advertisement to send to the first communication device based on at least one of a geographic location associated with the first communication device, a time of day associated with the first communication device, a demographic of a user associated with the first communication device, and behavioral information associated with the user associated with the first communication device.

16. A system for advertising over a communication medium, the system comprising:
an advertisement provider operative to detect an attempt by a first communication device to initiate communication with a second communication device, to send an advertisement to the first communication device, and to store an indication in an account record associated with the second communication device that the advertisement was sent to the first communication device based on the attempt to initiate communication with the second communication device.

17. The system of claim 16, wherein the advertisement provider is further operative to send a prompt to the first communication device to receive the advertisement and to receive a request from the first communication device to receive the advertisement.

18. The system of claim 16, wherein the advertisement provider is further operative to receive a request from the first communication device to receive a discount identifier associated with the advertisement, to send the discount identifier to the first communication device, and to store an indication in the account record associated with the second communication device that the discount identifier was sent to the first communication device based on the attempt to initiate communication with the second communication device.

19. The system of claim 18, wherein the advertisement provider is further operative to receive an indication that a transaction has associated with the discount identifier sent to the first communication device has been completed and to store an indication in the account record associated with the second communication device that the transaction was completed based on the attempt to initiate communication with the second communication device.

20. The system of claim 16, wherein the advertisement provider is further operative to identify the advertisement to send to the first communication device based on at least one of a geographic location associated with the first communication device, a time of day associated with the first communication device, a demographic of a user associated with the first communication device, and behavioral information associated with the user associated with the first communication device.
